(19) United States
(12) Patent Application Publication
(10) Pub. No.: US 2023/0091150 A1
(43) Pub. Date: Mar. 23, 2023

(54) METHOD OF RESISTANCE SPOT WELDING AND RESISTANCE SPOT WELDING APPARATUS

(71) Applicant: FUTABA INDUSTRIAL CO., LTD., Okazaki-shi (JP)

(72) Inventor: Keigo Yasuda, Okazaki-shi (JP)

(21) Appl. No.: 17/899,805

(22) Filed: Aug. 31, 2022

(30) Foreign Application Priority Data
Sep. 21, 2021 (JP) 2021-153185

(51) Int. Cl. B23K 11/11; B23K 11/30

(52) U.S. Cl. CPC B23K 11/115; B23K 11/3009; B23K 2103/04

(57) ABSTRACT

Provided is a method of resistance spot welding that can inhibit breakage of a high-tensile steel plate without materials being limited. One aspect of the present disclosure is a method of resistance spot welding including welding of a workpiece made of layered steel plates with a resistance spot welding apparatus. The resistance spot welding apparatus includes a first electrode contacting a first steel plate that is a high-tensile steel plate among the steel plates, and a second electrode contacting a second steel plate having less tensile strength than the first steel plate among the steel plates and configured such that the workpiece is interposed between the first electrode and the second electrode. In the welding, the first steel plate is compressed in a direction that intersects a thickness direction of the first steel plate at least from during welding of the workpiece until completion of welding of the workpiece.

### CROSS-REFERENCE TO RELATED APPLICATIONS

This application claims the benefit of Japanese Patent Application No. 2021-153185 filed on Sep. 21, 2021 with the Japan Patent Office, the entire disclosure of which is incorporated herein by reference.

### BACKGROUND

The present disclosure relates to a method of resistance spot welding and a resistance spot welding apparatus.

When performing resistance spot welding on a high-tensile steel plate (so-called high-tensile material) having a high tensile strength, tensile stress is generated in the welded portion when pressure from electrodes is released. This tensile stress is caused by resilience of the material and solidification of the melted portion.

Such tensile stress may cause breakage in the welded portion after welding. Thus, a method of inhibiting breakage by specifying an amount of zinc component contained in a steel plate has been invented (see, Japanese Unexamined Patent Application Publication No. 2020-179413).

### SUMMARY

In the aforementioned method of resistance spot welding, it is necessary to adjust the amount of zinc component contained in the steel plate; therefore, materials for the steel plate are limited. It is also necessary to repeat test production to bring the amount of zinc component into a specified range.

In one aspect of the present disclosure, it is preferable to provide a method of resistance spot welding that can inhibit breakage of a high-tensile steel plate without having materials be limited.

One aspect of the present disclosure is a method of resistance spot welding comprising welding a workpiece made of layered steel plates with a resistance spot welding apparatus. The resistance spot welding apparatus comprises a first electrode configured to contact a first steel plate that is a high-tensile steel plate among the steel plates; and a second electrode configured to contact a second steel plate having less tensile strength than the first steel plate among the steel plates and configured such that the workpiece is interposed between the first electrode and the second electrode. In the welding, the first steel plate is compressed in a direction that intersects a thickness direction of the first steel plate at least from during welding of the workpiece until completion of welding of the workpiece.

According to such configuration, the workpiece is welded in a state where compressive stress is generated in the first steel plate, which is a high-tensile steel plate. As a consequence, the compressive stress cancels tensile stress that is generated after welding; and therefore, breakage of the first steel plate is inhibited.

In one aspect of the present disclosure, in the welding, the first steel plate may be compressed in a direction that intersects the thickness direction of the first steel plate until cooling of the workpiece is completed after welding. According to such configuration, the compressive stress keeps being generated in the first steel plate until the cooling is completed, which is when generation of the tensile stress ends. This facilitates the effect of inhibiting the breakage.

In one aspect of the present disclosure, in the welding, the first steel plate may be compressed in a direction that intersects the thickness direction of the first steel plate from before welding of the workpiece is commenced. According to such configuration, welding of the workpiece can be commenced when the first steel plate is dynamically stable. As a consequence, quality of welding can be improved.

In one aspect of the present disclosure, in the welding, a welded portion of the first steel plate may be compressed in a direction that intersects the thickness direction of the first steel plate by interposing the first steel plate between a first pressurizing member and a second pressurizing member facing each other. According to such configuration, the compressive stress can be stably applied to the first steel plate.

Another aspect of the present disclosure is a resistance spot welding apparatus configured to weld a workpiece made of layered steel plates. The resistance spot welding apparatus comprises a first electrode configured to contact a first steel plate that is a high-tensile steel plate among the steel plates; a second electrode configured to contact a second steel plate having less tensile strength than the first steel plate among the steel plates and configured such that the workpiece is interposed between the first electrode and the second electrode; and a compressing mechanism configured to compress the first steel plate in a direction that intersects a thickness direction of the first steel plate at least from during welding of the workpiece until completion of welding of the workpiece.

According to such configuration, the compressive stress cancels the tensile stress that is generated after welding; and therefore, breakage of the first steel plate is inhibited.

In one aspect of the present disclosure, the compressing mechanism may be configured to compress the first steel plate in a direction that intersects the thickness direction of the first steel plate until cooling of the workpiece is completed after welding. According to such configuration, the compressive stress keeps being generated in the first steel plate until the cooling is completed, which is when generation of the tensile stress ends. This facilitates the effect of inhibiting the breakage.

In one aspect of the present disclosure, the compressing mechanism may be configured to compress the first steel plate in a direction that intersects the thickness direction of the first steel plate from before welding of the workpiece is commenced. According to such configuration, welding of the workpiece can be commenced when the first steel plate is dynamically stable. As a consequence, quality of welding can be improved.

In one aspect of the present disclosure, the compressing mechanism may comprise a first pressurizing member and a second pressurizing member that face each other. The first pressurizing member and the second pressurizing member may be configured to compress a welded portion of the first steel plate in a direction that intersects the thickness direction of the first steel plate by interposing the first steel plate between the first pressurizing member and the second pressurizing member. According to such configuration, the compressive stress can be applied to the first steel plate with accuracy.

### BRIEF DESCRIPTION OF THE DRAWINGS

An example embodiment of the present disclosure will be described hereinafter with reference to the accompanying drawings, in which:

FIG. 1 is a schematic drawing of a resistance spot welding apparatus of an embodiment;

FIG. 2A is a schematic drawing showing a process of welding a workpiece using the resistance spot welding apparatus;

FIG. 2B is a schematic drawing showing a process that comes after the process of FIG. 2A;

FIG. 2C is a schematic drawing showing a process that comes after the process of FIG. 2B;

FIG. 3A is a schematic drawing showing a process that comes after the process of FIG. 2C;

FIG. 3B is a schematic drawing showing a process that comes after the process of FIG. 3A; and

FIG. 4 is a flowchart of a method of resistance spot welding in the embodiment.

### DETAILED DESCRIPTION OF EXEMPLARY EMBODIMENTS

### 1. First Embodiment

[1-1. Configuration]

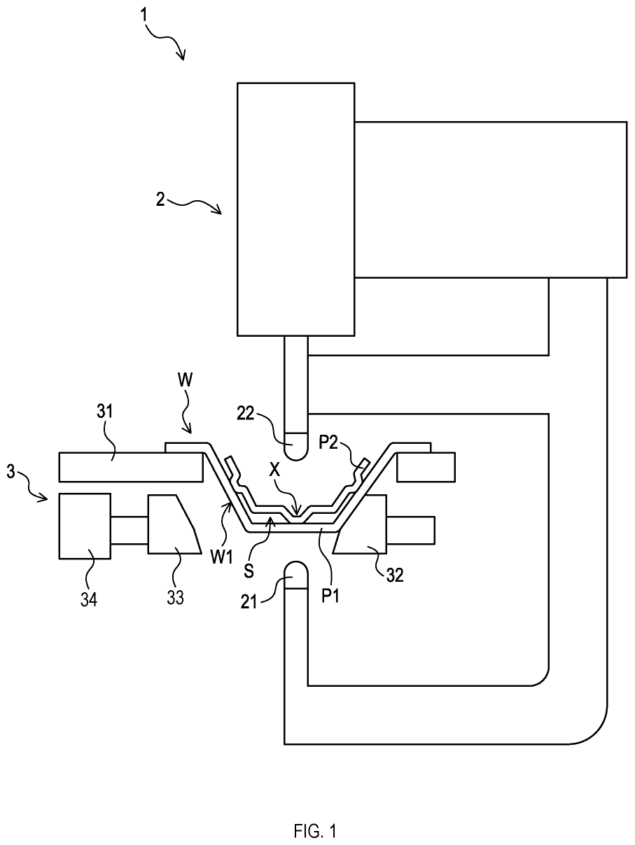

A resistance spot welding apparatus 1 shown in FIG. 1 is configured to weld a workpiece W made by layering a first steel plate P1 and a second steel plate P2. The resistance spot welding apparatus 1 includes a resistance welding device 2, and a compressing mechanism 3.

The first steel plate P1 is a so-called high-tensile steel plate and has a tensile strength of 980 MPa or greater and 3000 MPa or less. It is preferable that the tensile strength of the first steel plate P1 is 1180 MPa or greater. The second steel plate P2 is a non-high-tensile steel plate having a tensile strength of 270 MPa or grater and less than 980 MPa, or a high-tensile steel plate having a tensile strength less than that of the first steel plate P1. In the present embodiment, the second steel plate P2 is layered on top of the first steel plate P1.

The first steel plate P1 contacts the second steel plate P2 at a welded portion X. The first steel plate P1 also has an area that is separated from the second steel plate P2 in a thickness direction. In other words, the workpiece W comprises a gap S formed between the first steel plate P1 and the second steel plate P2.

The workpiece W comprises a projection W1 which protrudes downwardly. The welded portion X is arranged inside the projection W1. The second steel plate P2 is disposed inside a curved portion of the first steel plate P1 that forms the projection W1.

<Resistance Welding Device>

The resistance welding device 2 performs a resistance spot welding on the first steel plate P1 and the second steel plate P2, arranged as the workpiece W, in a thickness direction.

The resistance welding device 2 comprises a first electrode 21 and a second electrode 22. The first electrode 21 is placed below the workpiece W. The second electrode 22 is placed above the workpiece W such that the workpiece W is interposed between the first electrode 21 and the second electrode 22 in the thickness direction. The first electrode 21 is moveable in vertical directions with respect to the second electrode 22.

Each of the first electrode 21 and the second electrode 22 contacts the workpiece W during welding. Specifically, the first electrode 21 is configured to contact the first steel plate P1; and the second electrode 22 is configured to contact the second steel plate P2. A welding electric current flows between the first electrode 21 and the second electrode 22 via the workpiece W.

<Compressing Mechanism>

The compressing mechanism 3 is configured to compress the first steel plate P1 in a direction that intersects the thickness direction of the first steel plate P1 at least from during welding of the workpiece W until completion of welding of the workpiece W.

Specifically, the compressing mechanism 3 continues to compress the first steel plate P1 from before welding of the workpiece W is commenced until cooling of the workpiece W is completed after welding. The compressing mechanism 3 comprises a base 31, a first pressurizing member 32, a second pressurizing member 33, and a driver 34.

The base 31 is a member that supports the workpiece W. A peripheral portion of the projection W1 of the workpiece W is mounted on the base 31. The base 31 is arranged such that it does not vertically overlap with the welded portion X.

The first pressurizing member 32 and the second pressurizing member 33 are arranged such that they horizontally face each other. The first pressurizing member 32 and the second pressurizing member 33 compress a portion of the first steel plate P1 that includes at least the welded portion X by interposing the portion in a direction that intersects the thickness direction (specifically, a direction that is perpendicular to the thickness direction).

The driver 34 horizontally moves the second pressurizing member 33. The driver 34 is a cylinder that is driven by, for example, hydraulic pressure, air pressure, electric power, and a spring. The second pressurizing member 33 is moved by the driver 34 towards and away from the first pressurizing member 32.

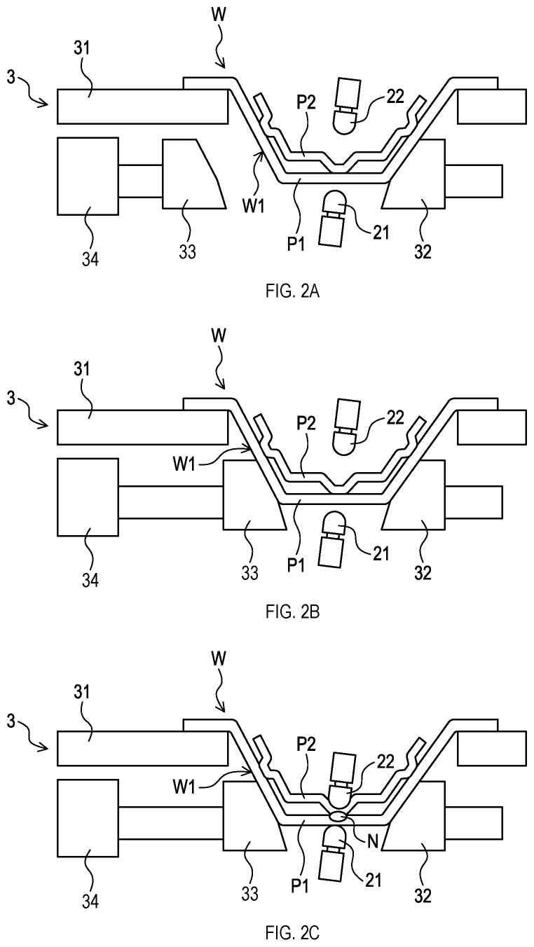

As shown in FIG. 2A, before welding is commenced (in other words, in a state where the first electrode 21 and the second electrode 22 are situated away from the workpiece W), only the first pressurizing member 32 comes into contact with the workpiece W. Specifically, the first pressurizing member 32 contacts the projection W1 of the workpiece W from outside.

From the state shown in FIG. 2A, the second pressurizing member 33 moves towards the first pressurizing member 32 to interpose the projection W1 of the workpiece W between the first pressurizing member 32 and the second pressurizing member 33 as shown in FIG. 2B. This causes a portion of the first steel plate P1, forming a bottom wall of the projection W1, to be compressed in a direction that intersects the thickness direction (specifically, a direction that is perpendicular to the thickness direction).

In the present embodiment, the second steel plate P2 is placed inside the first steel plate P1 forming the projection W1, and therefore the second steel plate P2 is not directly compressed by the first pressurizing member 32 and the second pressurizing member 33 in a direction that intersects the thickness direction. Nevertheless, the second steel plate P2 may be compressed in a direction that intersects the thickness direction with a compressing force smaller than the compressing force applied to the first steel plate P1.

In the state in which the first steel plate P1 is thus compressed, the resistance welding device 2 moves the first electrode 21 and the second electrode 22 as shown in FIG. 2C to apply pressure to the workpiece W in the thickness direction with the first electrode 21 and the second electrode 22.

The first steel plate P1 may be compressed by the first pressurizing member 32 and the second pressurizing member 33 after the pressure is applied to the workpiece W with the first electrode 21 and the second electrode 22. In the present embodiment, the direction in which the first electrode 21 and the second electrode 22 interpose the workpiece W is tilted with respect to the thickness direction of the first steel plate P1 at the welded portion. Nevertheless, the direction in which the first electrode 21 and the second electrode 22 interpose the workpiece W may be parallel to the thickness direction of the first steel plate P1 at the welded portion.

The resistance spot welding apparatus 1 supplies electric current between the first electrode 21 and the second electrode 22 interposing the workpiece W to perform welding of the workpiece W. As welding of the workpiece W progresses, a nugget N is formed at the welded portion of the workpiece W.

In other words, the resistance spot welding apparatus 1 performs welding of the workpiece W while having the welded portion of the first steel plate P1 compressed in a direction that intersects the thickness direction. Welding performed by the resistance spot welding apparatus 1 causes the first steel plate P1 and the second steel plate P2 to be joined by the nugget N in the thickness direction at the welded portion of the workpiece W.

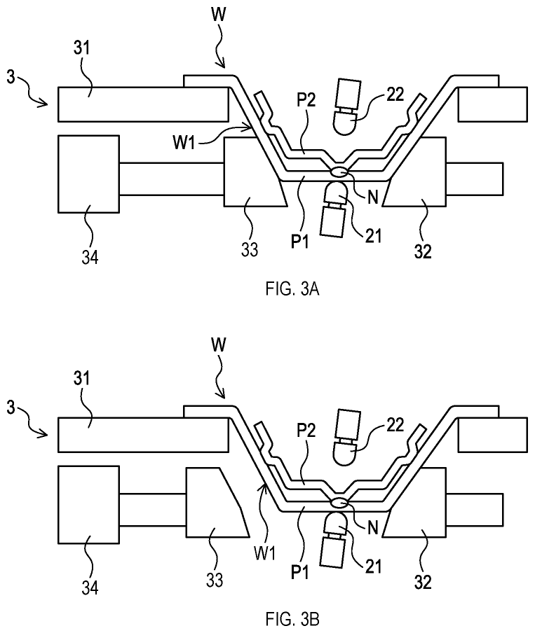

After welding is completed (in other words, after the supply of electric current is stopped), as shown in FIG. 3A, the resistance welding device 2 removes the second electrode 22 from the workpiece W while maintaining the compression of the first steel plate P1 by the first pressurizing member 32 and the second pressurizing member 33. During this state, cooling of the welded portion of the workpiece W is performed, for example, by the first electrode 21.

After cooling is completed, as shown in FIG. 3B, the resistance spot welding apparatus 1 releases the compression of the first steel plate P1 by moving the second pressurizing member 33 away from the workpiece W and the first pressurizing member 32.

[1-2. Method of Manufacturing]

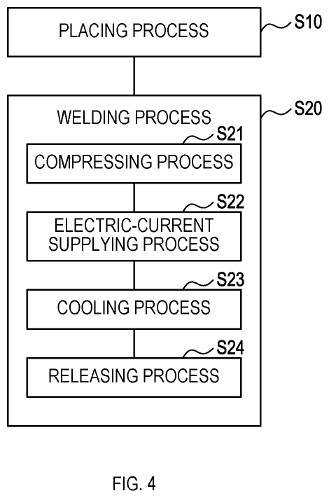

A method of resistance spot welding shown in FIG. 4 comprises a placing process S10, and a welding process S20. The method of resistance spot welding in the present embodiment is performed by using the resistance spot welding apparatus 1 as shown in FIG. 1, for example.

<Placing Process>

In this process, the workpiece W, which is formed by layering the first steel plate P1 and the second steel plate P2 in the thickness direction, is placed on the base 31 of the compressing mechanism 3 such that the first steel plate P1 is situated below the second steel plate P2.

A die used in press molding the first steel plate P1 may be arranged into a shape that causes a compressive stress to be generated in the first steel plate P1. This enables the first steel plate P1 to obtain the compressive stress in advance.

<Welding Process>

In this process, the first steel plate P1 and the second steel plate P2 that are layered are welded together by using the resistance spot welding apparatus 1. The welding process S20 comprises a compressing process S21, an electric-current supplying process S22, a cooling process S23, and a releasing process S24.

(Compressing Process)

In this process, the first steel plate P1 is compressed by the first pressurizing member 32 and the second pressurizing member 33 of the compressing mechanism 3 in a direction that intersects the thickness direction before the electric-current-supplying process S22 (in other words, before the welding is commenced).

(Electric-Current Supplying Process)

In this process, the workpiece W is interposed between the first electrode 21 and the second electrode 22 in a state where the first steel plate P1 is compressed by the compressing mechanism 3. Then, electric current is supplied between the first electrode 21 and the second electrode 22, and the workpiece W is welded while the first steel plate P1 is compressed.

(Cooling Process)

In this process, after the supply of electric current between the first electrode 21 and the second electrode 22 is stopped, the welded portion of the workpiece W is cooled in a state where the first steel plate P1 is compressed by the compressing mechanism 3.

(Releasing Process)

In this process, after cooling of the welded portion of the workpiece W is completed, the compression of the first steel plate P1 by the compressing mechanism 3 is released.

[1-3. Effects]

The embodiment described above in detail renders the following effects.

(1a) The workpiece W is welded in a state where the compressive stress is generated in the first steel plate P1, which is a high-tensile steel plate. Consequently, the tensile stress generated after welding is cancelled by the compressive stress, which then inhibit the breakage of the first steel plate P1.

(1b) The first steel plate P1 is kept compressed until the cooling of the workpiece W is completed. Consequently, the compressive stress continues to be generated in the first steel plate P1 until after the cooling is completed, which is when the generation of the tensile stress ends. The effect of inhibiting the breakage can therefore be facilitated.

(1c) The first steel plate P1 is compressed from before welding of the workpiece W is commenced. Consequently, welding of the workpiece W can be commenced when the first steel plate is dynamically stable. This enables an improvement of quality of welding.

(1d) The first steel plate P1 is interposed between the first pressurizing member 32 and the second pressurizing member 33 facing each other. This enables the first steel plate P1 to stably obtain the compressive stress.

### 2. Other Embodiments

An embodiment of the present disclosure has been explained above. Nevertheless, the present disclosure can be carried out in various modifications without being limited to the aforementioned embodiment.

(2a) In the resistance spot welding apparatus and the method of resistance spot welding of the aforementioned embodiment, the workpiece does not necessarily comprise a projection and a gap. For example, the workpiece may be formed by layering two or more flat steel plates without a gap.

(2b) In the resistance spot welding apparatus and the method of resistance spot welding of the aforementioned embodiment, the compressing mechanism may start compressing the first steel plate at the same time as or after commencement of welding. The compressing mechanism may release the compression of the first steel plate at the same time as completion of welding (in other words, an end of the supply of electric current) or during cooling.

(2c) In the resistance spot welding apparatus and method of resistance spot welding of the aforementioned embodiment, the workpiece may comprise three or more steel plates. In other words, there may be one or more steel plates arranged between the first steel plate and the second steel plate.

(2d) In the resistance spot welding apparatus and method of resistance spot welding of the aforementioned embodiment, the first steel plate may be layered on top of the second steel plate. Furthermore, a facing direction of the first electrode and the second electrode (that is, a direction the workpiece is interposed by the electrodes) is not limited to the vertical direction. For example, the first electrode and the second electrode may be configured to horizontally interpose the workpiece.

(2e) Functions of one element in the aforementioned embodiments may be achieved by two or more elements. Functions of two or more elements may be integrated into one element. A part of the configuration in the aforementioned embodiments may be omitted. At least a part of the configuration in the aforementioned embodiments may be added to or replaced with other part of the configuration in the aforementioned embodiments. It should be noted that any and all modes included in the technical ideas that are identified by the languages recited in the claims are embodiments of the present disclosure.

What is claimed is:

1. A method of resistance spot welding, the method comprising welding a workpiece made of layered steel plates with a resistance spot welding apparatus,
the resistance spot welding apparatus comprising:
a first electrode configured to contact a first steel plate that is a high-tensile steel plate among the steel plates; and
a second electrode configured to contact a second steel plate having less tensile strength than the first steel plate among the steel plates and configured such that the workpiece is interposed between the first electrode and the second electrode,
wherein, in the welding, the first steel plate is compressed in a direction that intersects a thickness direction of the first steel plate at least from during welding of the workpiece until completion of welding of the workpiece.

2. The method of resistance spot welding according to claim 1,
wherein, in the welding, the first steel plate is compressed in a direction that intersects the thickness direction of the first steel plate until cooling of the workpiece is completed after welding.

3. The method of resistance spot welding according to claim 1,
wherein, in the welding, the first steel plate is compressed in a direction that intersects the thickness direction of the first steel plate from before welding of the workpiece is commenced.

4. The method of resistance spot welding according to claim 1,
wherein, in the welding, a welded portion of the first steel plate is compressed in a direction that intersects the thickness direction of the first steel plate by interposing the first steel plate between a first pressurizing member and a second pressurizing member facing each other.

5. A resistance spot welding apparatus configured to weld a workpiece made of layered steel plates, the apparatus comprising:
a first electrode configured to contact a first steel plate that is a high-tensile steel plate among the steel plates;
a second electrode configured to contact a second steel plate having less tensile strength than the first steel plate among the steel plates and configured such that the workpiece is interposed between the first electrode and the second electrode; and
a compressing mechanism configured to compress the first steel plate in a direction that intersects a thickness direction of the first steel plate at least from during welding of the workpiece until completion of welding of the workpiece.

6. The resistance spot welding apparatus according to claim 5,
wherein the compressing mechanism is configured to compress the first steel plate in a direction that intersects the thickness direction of the first steel plate until cooling of the workpiece is completed after welding.

7. The resistance spot welding apparatus according to claim 5,
wherein the compressing mechanism is configured to compress the first steel plate in a direction that intersects the thickness direction of the first steel plate from before welding of the workpiece is commenced.

8. The resistance spot welding apparatus according to claim 5,
wherein the compressing mechanism comprises a first pressurizing member and a second pressurizing member that face each other, and
wherein the first pressurizing member and the second pressurizing member are configured to compress a welded portion of the first steel plate in a direction that intersects the thickness direction of the first steel plate by interposing the first steel plate between the first pressurizing member and the second pressurizing member.
